(19) United States
(12) Patent Application Publication
(10) Pub. No.: US 2009/0197625 A1
(43) Pub. Date: Aug. 6, 2009

(54) METHOD AND SYSTEM FOR GRANTING A CLIENT TALK BURST AND PUSH TO TALK OVER CELLULAR SERVER

(75) Inventor: Wangguang Zhang, Shenzhen (CN)

Correspondence Address: Leydig, Voit & Mayer, Ltd;(for Huawei Technologies Co., Ltd), Two Prudential Plaza Suite 4900, 180 North Stetson Avenue, Chicago, IL, 60601, US

(73) Assignee: HUAWEI TECHNOLOGIES CO., LTD., Shenzhen (CN)

(21) Appl. No.: 12/421,743

(22) Filed: Apr. 10, 2009

Related U.S. Application Data
(63) Continuation-in-part of application No. PCT/CN2008/070081, filed on Jan. 10, 2008.

(30) Foreign Application Priority Data
Jan. 31, 2007 (CN) 200710003126.4

(51) Int. Cl. H04B 7/00

(52) U.S. Cl. 455/518

(57) ABSTRACT

A method for granting a client talk burst (TB) includes the following steps. a push to talk over cellular (PoC) server receives a TB request message from a TB requesting client. If the TB requesting client is a client with the preemptive priority, the PoC server revokes a TB taken by a permitted client, and grants the TB to the client with the preemptive priority. Meanwhile, the disclosure further provides a system for granting a terminal TB and a PoC server. Through the method, system, and the PoC server provided by the disclosure, it is ensured that the client at the preemptive level may grab the TB taken by the client with a lower TB priority simply through pressing a key once, so as to enhance the users' experience.

### CROSS-REFERENCE TO RELATED APPLICATIONS

The application is a continuation-in-part of International Application No. PCT/CN2008/070081, filed on Jan. 10, 2008, which claims the priority to Chinese Patent Application No. 200710003126.4, filed on Jan. 31, 2007, both of which are hereby incorporated by reference in their entirety.

### FIELD OF THE TECHNOLOGY

The disclosure relates to network communication technology, and more particularly to a method and system for granting a client talk burst (TB), and a push to talk over cellular (PoC) server.

### BACKGROUND

PoC service is a mobile data service with an intercom function developed on a public mobile network. The PoC service is a bi-directional, instant, and multi-party communication scheme, which allows one client to communicate with one or more clients. The PoC service originates from a cluster communication service (push to talk service). The push to talk service is capable of providing one-to-one and one-to-many conversations upon a key pressing. It does not require dialing or waiting, and provides users with intercom experiences. The one-to-many conversation includes a temporary group session, an instant group session, and a chat group session.

The PoC service is a half-duplex communication service, which merely allows one client to have a client talk burst (TB) at one moment, and the other clients to be in a talk receiving state according to a TB control. If the other clients want to talk, they must first acquire the TB, so that the TB taken by the former client may be acquired. The so-called TB control refers to achieving a Talk Burst Control Protocol (TBCP) function over a Real Time Transmission Control Protocol (RTCP), that is, a client sends a TB request message during a session to a PoC server, then the PoC server determines whether to grant the TB to the client or not, according to the current PoC server state for general Talk Burst and the priority of the client sending the TB request message.

The PoC server is a core member in the PoC service. The PoC server state for general Talk Burst during the process of granting the TB is introduced as follows.

In State 1: the PoC server state for general Talk Burst is in a Talk Burst Taken (TB_Taken) state. The PoC server in the TB_Taken state is continuously in the state of receiving and sending media packets.

In State 2: the PoC server enters a Talk Burst Revoke (TB_Revoke) pending state. In the TB_Revoke pending state, the PoC server receives a Talk Burst Request (TB_Request) message with a preemptive message sent from a TB requesting client B. Firstly, the Talk Burst priority level carried by the TB requesting client B is determined, and if the Talk Burst priority level of the client B is higher than that of a client A in the TB_Taken state, or the Talk Burst priority level is at a preemptive level, the PoC server sends a TB_Revoke message to the client A, in which the level of three is set as the preemptive level.

In State 3: the PoC server enters a Talk Burst Idle (TB_Idle) state. Once entering the TB_Revoke pending state, the PoC server immediately starts a timer (Stop talking grace timer) thereof. When the timer is timeout, or the PoC server receives a message that the client A in the TB_Taken state has sent the last media packet, the PoC server enters the TB_Idle state from the TB_Revoke pending state.

In State 4: the PoC server enters the TB_Taken state. After the PoC server enters the TB_Idle state, if receiving a Talk Burst Request (TB_Request) message from a TB requesting client B in the state, the PoC server sends a Talk Burst Granted (TB_Granted) message to the client B, sends the TB_Taken message to the client A, and enters the TB_Taken state from the TB_Idle state.

It may be known from the PoC state conversion process that, after the client A in the TB_Taken state releases the TB, the PoC server in the TB_Revoke pending state can only be converted to the TB_Idle state, but cannot be directly converted to the TB_Taken state. Therefore, the TB requesting client B may acquire the TB only by initiating the TB_Request message through pressing the key twice. In addition, if a client C initiates the TB_Request message at the instant when the client A in the TB_Taken state releases the TB, the PoC server grants the TB to the client C, and as a result, the client B, which initiates the TB_Request message at the earliest circumstance, does not acquire the TB.

As known from the above, in existing systems, when the PoC service is developed, the client with the preemptive priority may not acquire the TB taken by the permitted client through pressing the key once. As a result, the client will wait for a long time, and the user's experience is deteriorated.

### SUMMARY

According to an embodiment of the disclosure, a method for granting a client TB is provided, which includes the following steps: a PoC server receives a TB request message sent by a TB requesting client; the PoC server revokes a TB taken by a permitted client (client in a TB_Taken state) when the TB requesting client is a client with the preemptive priority, and granting the TB to the client with the preemptive priority.

According to an embodiment of the disclosure, a system for granting a client TB is provided, which includes a TB requesting client and a PoC server. The TB requesting client is adapted to initiate a TB request message to PoC server. The PoC server is adapted to revoke a TB taken by a user terminal in a TB_Taken state when the TB requesting client is a client with the preemptive priority, and grant the TB to the client with the preemptive priority.

According to an embodiment of the disclosure, a PoC server for granting a client TB is provided, which includes a media processing module, a TB_Taken processing module and a TB_Request preemptive pending processing module. The media processing module, adapted to receive a TB request message from a TB requesting client, and sends the TB request message. The TB_Taken processing module, adapted to receive the TB request message from the media processing module, determine whether the TB requesting client is a client with the preemptive priority or not, and if it is a client with the preemptive priority, revoke a TB taken by a permitted client. The TB_Request preemptive pending processing module, adapted to grant the TB to the client with the preemptive priority after the TB_Taken processing module revokes the TB taken by the permitted client.

According to an embodiment of the disclosure, a method and a system for granting a client TB and a PoC server are provided. The PoC server in the TB_Taken state receives the TB request message from the TB requesting client. When it is determined that the Talk Burst priority level carried by the TB request message is the preemptive level, the PoC server revokes the TB taken by the permitted client, and grants the TB to the client in the TB requesting state.

As known from the above, the client with the preemptive priority may grab the TB taken by the client with a lower Talk Burst priority level merely through pressing the key once. Therefore, the disclosure provides a simple and reliable TB_Request preemptive function, which enhances the users' experience.

### BRIEF DESCRIPTION OF THE DRAWINGS

FIG. 1 is a schematic structural view of a system for granting a terminal TB in a PoC service according to an embodiment of the disclosure;

FIG. 2 is a schematic structural view of a PoC server according to an embodiment of the disclosure;

FIG. 3 is another schematic structural view of a PoC server according to an embodiment of the disclosure;

FIG. 4 is a flow chart of a method for granting a TB in a PoC service according to an embodiment of the disclosure;

FIG. 5 is a flow chart of a state conversion of a PoC server when granting client TB according to an embodiment of the disclosure; and

FIG. 6 is another flow chart of a method for granting a client TB in a PoC service according to an embodiment of the disclosure.

### DETAILED DESCRIPTION

FIG. 1 is a schematic structural view of a system for granting a client TB in a PoC service according to an embodiment of the disclosure. As shown in FIG. 1, the system includes a client and a PoC server.

The client in a TB requesting state is adapted to send a TB_Request message to the PoC server in a TB_Taken state, receive a TB_Granted message sent from the PoC server, and acquire the TB.

The PoC server is adapted to receive the TB_Request message from the client in the TB requesting state. When it is determined that the Talk Burst priority level in the TB_Request message is preemptive, the PoC server is further adapted to determine a Talk Burst priority level of a permitted client. When the Talk Burst priority level of the permitted client is not the preemptive level, the PoC server is adapted to send a TB_Revoke message and a TB_Taken message to the permitted client, and inform the permitted client to release the TB. The PoC server is also adapted to send a TB_Granted message to the client in the TB requesting state.

It should be noted that, the client in the TB requesting state refers to the client that applies to the PoC server for the TB. The permitted client refers to the client currently occupying the TB.

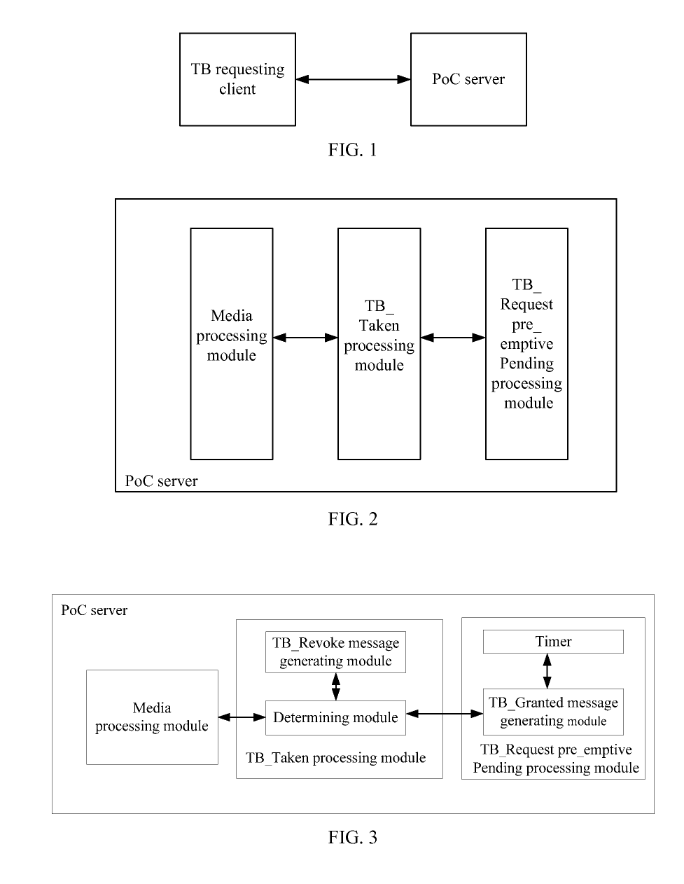

FIG. 2 is a schematic structural view of a PoC server according to an embodiment of the disclosure. As shown in FIG. 2, the PoC server includes a media processing module, a TB_Taken processing module, and a TB_Request preemptive pending processing module.

The media processing module is adapted to receive a TB_Request message from a client in the TB requesting state, and send the TB_request message to the TB_Taken processing module.

The TB_Taken processing module is adapted to receive the TB_Request message, determine whether the client in the TB requesting state is a client with the preemptive priority or not, and if yes, revoke the TB taken by the permitted client.

The TB_Request preemptive pending processing module is adapted to grant the TB to the client with the preemptive priority, when the TB_Taken processing module revokes the TB taken by the permitted client.

In the embodiment shown in FIG. 2, the structural view of the PoC server for granting the client TB has been introduced. The internal structure of the other PoC servers is further described below.

FIG. 3 is another schematic structural view of a PoC server according to an embodiment of the disclosure. As shown in FIG. 3, similarly, the PoC server includes a media processing module, a TB_Taken processing module, and a TB_Request preemptive pending processing module. Compared with the embodiment shown in FIG. 2, the TB_Taken processing module in the PoC server includes a determining module and a TB_Revoke message generating module. The TB_Request preemptive pending processing module includes a TB_Granted message generating module and a timer (for example, T3 timer)

In this embodiment, a client in a TB requesting state, sends a RTP/RTCP packet carrying the TB_Request message to the media processing module, receives the TB_Granted message sent from the media processing module, and acquires the TB.

The determining module is adapted to receive the TB_Request message sent from the media processing module, determine a Talk Burst priority level of the client in the TB requesting state and that of a permitted client, and send the determination result to the TB_Revoke message generating module.

The TB_Revoke message generating module is adapted to receive the determination result. When the Talk Burst priority level of the client in the TB requesting state is the preemptive level, and the Talk Burst priority level of the permitted client is not the preemptive level, the TB_Revoke message generating module generates a TB_Revoke message, and sends the TB_Revoke message to the permitted client.

The TB_Granted message generating module is adapted to receive a timeout message sent from the timer and/or a Talk Burst Release (TB_Release) message sent from the permitted client. Upon receiving at least one of the timeout message and the TB_Release message, the TB_Granted message generating module generates the TB_Granted message, and sends the TB_Granted message to the client in the TB requesting state. When receiving the TB_Release message and meanwhile acquiring a message from the received TB_Release message that the permitted client has already sent out the last media packet, the TB_Granted message generating module generates the TB_Granted message.

The timer (T3 timer) is adapted to perform timing and send the timeout message to the TB_Granted message generating module.

It should be noted that, the embodiment of the disclosure provides a schematic structural view; the media processing module, the TB_Taken processing module, and the TB_Request preemptive pending processing module are further divided in the PoC server. However, the embodiment is merely a preferred embodiment of the technical solution of the disclosure, but not to limit the protection scope of the disclosure. Other combining manners, for example, the PoC server including the media processing module, the TB_Taken processing module, the TB_Granted message generating module, and the timer (T3 timer); or, the PoC server including the media processing module, the determining module, the TB_Revoke message generating module, and the TB_Request preemptive pending processing module also fall within the protection scope of the disclosure.

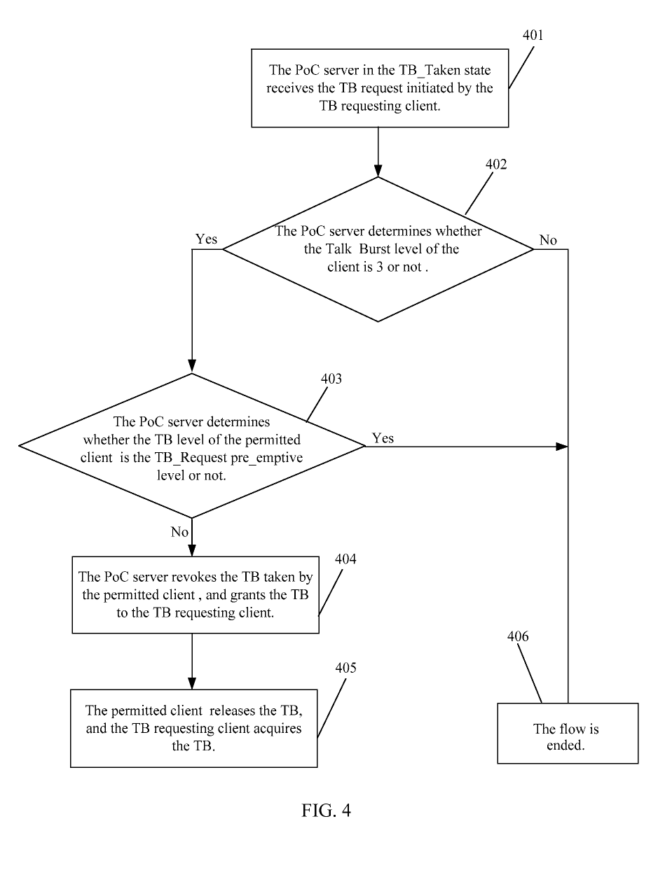

In the embodiment shown in FIGS. 1, 2, and 3, the system for granting a client TB in the PoC service and the PoC server have been introduced. In another embodiment shown in FIG. 4, a method for a client with the Talk Burst priority level of preemptive level grabbing the TB taken by the permitted client is introduced.

FIG. 4 is a flow chart of a method for granting a client TB in a PoC service according to an embodiment of the disclosure. As shown in FIG. 4, the method includes the following steps.

In Step 401, a PoC server in a TB_Taken state receives a TB request message sent by a client in the TB requesting state.

In the step, the client in the TB requesting state initiates the TB_Request message to the PoC server in the TB_Taken state; the TB_Request message carries the Talk Burst priority level of the client in the TB requesting.

In Step 402, the PoC server determines the Talk Burst priority level of the client. If the Talk Burst priority level is the preemptive level, Step 404 is executed. Optionally, step 403 may be executed; otherwise, Step 406 is executed.

In this step, for example, the PoC server determines whether the Talk Burst priority level of the client in the TB requesting state is 3 (3 stands for the preemptive level) or not. If the level of the client is 3, it is determined that the Talk Burst priority level of the client in the TB requesting state is the preemptive level.

In Step 403, the PoC server determines the Talk Burst priority level of the permitted client. If the Talk Burst priority level is not the pre emptive level, Step 404 is executed; otherwise, Step 406 is executed.

In this step, for example, the PoC server determines whether the Talk Burst priority level of the permitted client is 3 (3 stands for the preemptive level) or not, and if the level of the client is not 3, it is determined that the Talk Burst priority level of the permitted client is not the preemptive level.

In Step 404, the PoC server revokes the TB taken by the permitted client, and grants the TB to the client in the TB requesting state.

In this step, after receiving the TB_Request message, the PoC server sends the TB_Revoke message to the permitted client and enters a TB_Request preemptive pending state. The PoC server in the TB_Request preemptive pending state sends the TB_Taken message to the permitted client, informs the user to release the TB, sends the TB_Granted message to the client in the TB requesting state, and grants the TB to the client in the TB requesting state.

In Step 405, the permitted client releases the TB, and the client in the TB requesting state acquires the TB.

In Step 406, the flow is ended.

In the embodiment shown in FIG. 4, the flow of the method for the client carrying the preemptive priority grabbing the TB taken by the permitted client in the PoC service has been introduced. Step 402 and Step 403 can be reversed, that is, the PoC server may firstly determine the Talk Burst priority level of the TB requesting client, or may also firstly determine the Talk Burst priority level 1 of the permitted client.

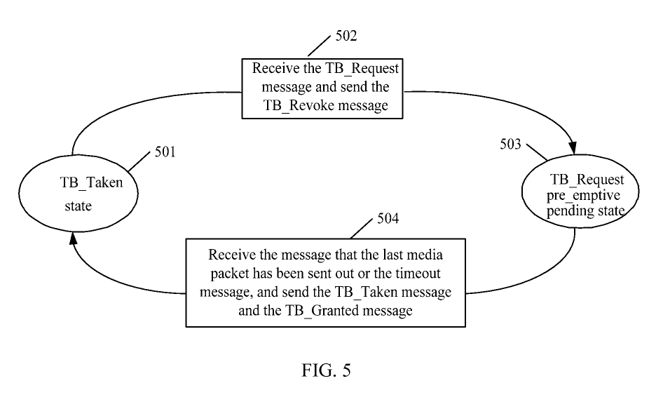

In another embodiment shown in FIG. 5, the TB state conversion process for the PoC server when grabbing the TB through adopting the embodiment of the disclosure is introduced.

FIG. 5 is a schematic view of the flow of the state conversion process of the PoC server during the client TB granting process of the embodiment of the disclosure.

Referring to FIG. 5, in State 501, a PoC server is in a TB_Taken state.

In this state, if the PoC server is continuously in a state of receiving and sending media packets, the PoC server is in the TB_Taken state.

In State 502, the PoC server is converted from the TB_Taken state to a TB_Revoke preemptive state.

In this state, the PoC server receives a TB_Request message from a client in the TB requesting state. When it is determined that the Talk Burst priority level carried in the TB_Request message is the preemptive priority, and the Talk Burst priority level of a permitted client is not the preemptive level, the PoC server sends a TB_Revoke message to the permitted client. The PoC server is converted to the TB_Revoke preemptive state.

In State 503, the PoC server enters the TB_Revoke preemptive state.

In this state, once the PoC server enters the TB_Revoke preemptive state, the PoC server immediately starts a timer (such as T3 timer). The PoC server in the TB_Revoke preemptive state receives a TB_Release message sent from the permitted client. If the TB_Release message does not carry a message about the last media packet sequence number, or the timer (such as T3 timer) does not time out, the PoC server is always in the TB_Revoke preemptive state.

In State 504, the PoC server is converted from the TB_Revoke preemptive state to the TB_Taken state.

In this state, the PoC server acquires the message about the last media packet sequence number from the TB_Release message, which indicates that the permitted client has sent the last media packet, or the timer (such as T3 timer) started in State 503 is timeout. After sending the TB_Taken message to the permitted client, and sending the TB_Granted message to the client in the TB requesting state, the PoC server is converted to the TB_Taken state.

As compared with the traditional art, in the embodiment shown in FIG. 5, once the PoC server receives the TB_Request message carrying the TB_Request preemptive priority sent from the client in the TB requesting state, the PoC server automatically enters the TB_Revoke preemptive state, and revokes the TB taken by the permitted client within a specified time period. After the permitted client releases the TB, the PoC server immediately grants the TB to the client in the TB requesting state, and meanwhile, enters the TB_Taken state. Therefore, the client in the TB requesting state is allowed to grab the TB merely through pressing the key once.

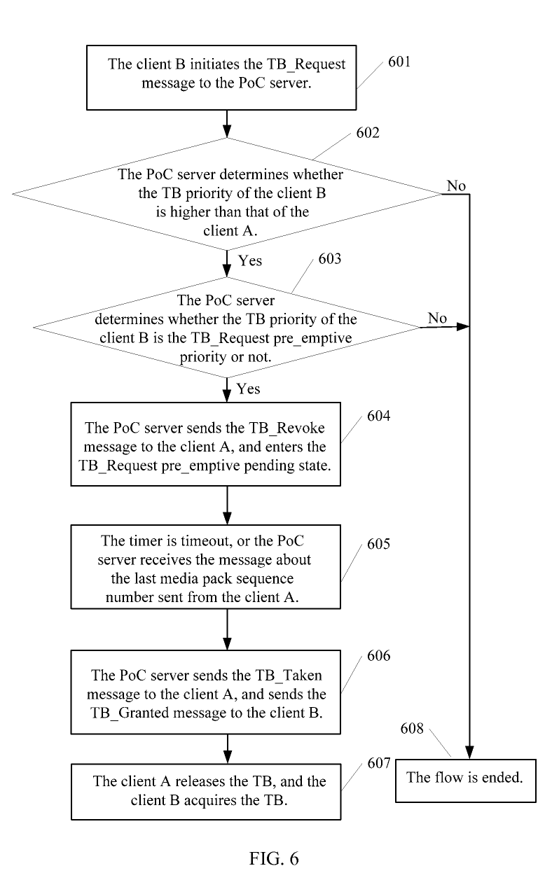

FIG. 6 is another flow chart of a method for granting a client TB in a PoC service according to an embodiment of the disclosure. As shown in FIG. 6, the method includes the following steps.

In Step 601, a client B initiates a TB_Request message to the PoC server.

In this step, a client A occupies a TB, the PoC server is in the TB_Taken state, and the client B initiates the TB_Request message to the PoC server.

In Step 602, the PoC server determines the TB priority levels of the client B and the client A. If the TB priority level of the client B is higher than that of the client A, Step 603 is executed; otherwise, Step 608 is executed.

In this step, the manner of comparing the TB priority level of the client B with that of the client A is the similar to that in the traditional art, which will not be elaborated herein.

In Step 603, the PoC server determines whether the TB priority level of the client B is the TB_Request preemptive priority or not, and if yes, Step 604 is executed; otherwise, Step 608 is executed.

In this step, the PoC server determines whether the TB priority of the client B is 3 (3 stands for the preemptive level) or not, and if yes, it is determined that the TB priority of the client B is the TB_Request preemptive priority, and Step 604 is executed. Otherwise, it is determined that the TB priority of the client B is not the TB_Request preemptive priority, and Step 608 is executed.

In Step 604, the PoC server sends a TB_Revoke message to the client A.

In Step 605, the T3 timer times out, or the PoC server receives the message about the last media packet sequence number sent from the client A.

In this step, once the PoC server enters the TB_Revoke preemptive state from the TB_Taken state, the PoC server starts the T3 timer. If the T3 timer times out, or the PoC server receives the message about the last media packet sequence number carried in the TB_Release message sent from the client A, which indicates the client A has sent the last media packet.

In Step 606, the PoC server sends the TB_Taken message to the client A, and sends the TB_Granted message to the client B.

In this step, the PoC server sends the TB_Taken message to the client A, and informs the client A to completely release the TB. The PoC server sends the TB_Granted message to the client B, and informs the client B that the TB can be taken by client B.

In Step 607, the client A releases the TB, and the client B acquires the TB.

In this step, the process for the client A to release the TB includes: once the client A receives the TB_Revoke message, the TB is automatically released, or the PoC server forcefully grabs the TB of the client A. The process for the PoC server to forcefully grab the TB taken by the client A includes: after sending the TB_Taken message to the client A, the PoC server immediately starts the T3 timer, and monitors the time spent on releasing the TB by the client A. If the client A still does not release the TB when the T3 timer times out, the PoC server forcefully grabs the TB taken by the client A.

In Step 608, the flow is ended.

Till now, the operations for the client B to grab the TB taken by the client A have been finished.

It should be noted that, in this embodiment, it may firstly determine whether the client B is the client with the preemptive priority or not; and if yes, the TB priority of the client B is compared with that of the client A. If the TB priority of the client B is higher than that of the client A, Step 604 is executed. In addition, in this embodiment, the client B is the client in the TB requesting state, and the client A is the permitted client.

Through comparing the embodiments shown in FIGS. 4 and 6, it is found that the technical solution of the embodiment shown in FIG. 4 is that, the PoC server firstly determines whether the Talk Burst priority level of the TB requesting client is the preemptive level or not, and if yes, it further determines whether the Talk Burst priority level of the permitted client is the preemptive level or not. If the Talk Burst priority level of the permitted client is not the preemptive level, Step 404 and Step 405 are executed. The detailed technical solution of the embodiment shown in FIG. 6 is that, the PoC server determines whether the Talk Burst priority level of the TB requesting client is higher than that of the permitted client or not. If yes, it further determines whether the Talk Burst priority level of the TB requesting client is the preemptive priority or not; and if yes, the subsequent Step 604 to Step 607 are executed.

In this embodiment, after receiving the TB_Release message sent from the client A, the PoC server in the TB_Revoke preemptive state periodically enters the TB_Revoke preemptive state. In the embodiment shown in FIG. 1, after sending the TB_Revoke message to the client A, the PoC server in the TB_Taken state enters the TB_Revoke pending state. In the embodiment of the disclosure, after sending the TB_Granted message to the client B, the PoC server in the TB_Taken state enters the TB_Revoke pending state.

When the method and system for granting a terminal TB in the PoC service according to the embodiment of the disclosure are introduced, the TB_Taken state, TB_Revoke pending state, and TB_Revoke preemptive state of the TB state machine in the PoC server are introduced. Other states of the TB state machine in the PoC server and the state conversion among each state according to the embodiments of the disclosure are completely the same as that of the traditional art, such as the conversion from the TB_Idle state to a Releasing state, which will not be elaborated herein. In the embodiments of the disclosure, only the TB_Revoke preemptive state and the corresponding process are added into the TB state machine of the PoC server, without changing other solutions, so that the TB migration state flow specified in the Open Mobile Alliance (OMA) regulation is not affected at all, and thus the users' experience in the other aspects may not be affected.

To sum up, the above descriptions are merely taken as preferred embodiments of the disclosure, but not to limit the protection scope of the disclosure.

Finally, it should be understood that the above embodiments are only used to explain, but not to limit the technical solution of the present invention. Despite the detailed description of the present invention with referring to above preferred embodiments, it should be understood that various modifications, changes or equivalent replacements can be made by those skilled in the art without departing from the spirit and scope of the present invention and covered in the claims of the present invention.

What is claimed is:

1. A method for granting a client talk burst (TB), comprising:
receiving, by a push to talk over cellular (PoC) server, when the PoC server is in a TB_Taken state, a TB request message sent by a TB requesting client; and
revoking, by the PoC server, a TB taken by a permitted client when the PoC server determines that the TB requesting client has a preemptive priority, and granting the TB to the TB requesting client.

2. The method according to claim 1, wherein revoking, by the PoC server, the TB taken by a permitted client comprises:
determining whether the permitted client has the preemptive priority or not, and if the permitted client does not have the preemptive priority, revoking the TB taken by the permitted client.

3. The method according to claim 1, wherein revoking, by the PoC server, the TB taken by the permitted client comprises:
revoking the TB taken by the permitted client when a TB priority level of the TB requesting client is higher than that of the permitted client.

4. The method according to claim 1, wherein
the PoC server determines that the TB requesting client has the preemptive priority, when a preemptive TB priority level is carried in the TB request message.

5. The method according to claim 1, wherein revoking, by the PoC server, the TB taken by the permitted client comprises:
sending, by the PoC server, a Talk Burst Revoke (TB_Revoke) message to the permitted client, and entering a Talk Burst Request (TB_Request) preemptive pending state;
sending, by the PoC server in the TB_Request preemptive pending state, a TB_Taken message to the permitted client; and
receiving, by the permitted client, the TB_Taken message and releasing the TB.

6. The method according to claim 5, wherein granting the TB to the TB requesting client comprises:
sending a Talk Burst Granted (TB_Granted) message to the TB requesting client with the preemptive priority; and
receiving, by the TB requesting client, the TB_Granted message and acquiring the TB.

7. The method according to claim 1 wherein revoking, by the PoC server, the TB taken by the permitted client comprises at least one of:
starting a timer, and revoking, by the PoC server, the TB taken by the permitted client when the timer times out; and
revoking, by the PoC server, the TB taken by the permitted client when the permitted client sends out a last media packet.

8. The method according to claim 6, wherein after granting the TB to the TB requesting client, the method further comprises:
entering, by the PoC sever, a TB_Taken state from the TB_Request preemptive pending state and providing a service for the TB requesting client.

9. A system for granting a client TB, comprising:
a TB requesting client, for initiating a TB request message; and
a push to talk over cellular (PoC) server, for receiving the TB request message, revoking a TB taken by a permitted client when the TB requesting client has a preemptive priority, and granting the TB to the TB requesting client.

10. The system according to claim 9, wherein the PoC server comprises:
a media processing module, for receiving the TB request message sent by the TB requesting client and sending the TB request message;
a TB_Taken processing module, for receiving the TB request message from the media processing module, determining whether the TB requesting client has the preemptive priority or not, and if the TB requesting client has the preemptive priority, revoking the TB taken by the permitted client; and
a TB_Request preemptive pending processing module, for granting the TB to the TB requesting client after the TB_Taken processing module revokes the TB taken by the permitted client.

11. A push to talk over cellular (PoC) server, comprising:
a media processing module, for receiving a TB request message sent by a TB requesting client and sending the TB request message;
a TB_Taken processing module, for receiving the TB request message from the media processing module, determining whether the TB requesting client has a preemptive priority or not, and if the TB requesting client has the preemptive priority, revoking the TB taken by a permitted client; and
a TB_Request preemptive pending processing module, for granting the TB to the TB requesting client after the TB_Taken processing module revokes the TB taken by the permitted client.

12. The server according to claim 11, wherein the TB_Taken processing module comprises:
a determining module, for receiving the TB request message from the media processing module, determining a Talk Burst priority level of the TB requesting client, and sending a determination result; and
a TB_Revoke message generating module, for receiving the determination results, and revoking the TB taken by the permitted client when the Talk Burst priority level of the TB requesting client is a TB_Request preemptive level.

13. The server according to claim 11, wherein the TB_Request preemptive pending processing module comprises:
a timer, for performing timing and sending a timeout message; and
a TB_Granted message generating module, for granting the TB to the TB requesting client when receiving one of the timeout message and a Talk Burst Release (TB_Release) message from the permitted client.
